(19) United States
(12) Patent Application Publication
(10) Pub. No.: US 2001/0034711 A1
(43) Pub. Date: Oct. 25, 2001

(54) Distributed operating network and method for using and implementing same

(76) Inventor: Bradley A. Tashenberg, Houston, TX (US)

Correspondence Address: ROBERT W STROZIER, PLLC, 2925 BRIARPARK, SUITE 930, HOUSTON, TX, 77042, US

(21) Appl. No.: 09/797,433

(22) Filed: Mar. 1, 2001

Related U.S. Application Data
(60) Provisional application No. 60/185,995, filed on Mar. 1, 2000.

(51) Int. Cl. G06F 17/60

(52) U.S. Cl. 705/52

(57) ABSTRACT

A distributed operating network is disclose where an operating kernel is commonly installed on all DPUs in the operating network interconnected with at least one interconnecting network where the computer include remote user DPUs and servers where the servers comprise a server system. The server system includes an application repository, user registration, identification and verification routines, accounting and billing routines, user activity tracking routines and timekeeping routines. Each DPU has access to all application software on the operating network which can be used on a time of use based billing system and the kernel is expanded with selected applications and needed dynamic routines for optimal performance on the requesting DPU which allows the DPU to be minimally configured. Additional hardware is available to all remote DPUs on a time use base billing system as well as distributed computing and resource sharing.

### RELATED APPLICATIONS

This application claims provisional priority to United States Provisional Patent Application Ser. No. 60/185,995 filed Mar. 1, 2000, incorporated herein by reference.

### BACKGROUND OF THE INVENTION

1. Field of the Invention

The present invention relates an operating network including a server system, a plurality of remote computers and a network interconnecting the server system and the remote computers and methods for implementing and using the operating network.

More particularly, the present invention relates to an operating network including a server system, a plurality of remote computers and a network interconnecting the server system and the remote computers where the operating network includes a kernel, a device driver library, an application library, dynamic libraries, a billing system, a user profile database, a user login system having a registration sub-system and a user verification subsystem, communication software, etc. and the servers include memory, mass storage devices, digital processing units, communications hardware and software, and peripherals and where the remote computers include memory, optional mass storage devices, digital processing units, communications hardware and software and peripherals and the kernel and where applications and needed dynamic libraries are obtained from the server system over the network on a permanent or temporary basis and methods for implementing and using the operating network.

2. Description of the Related Art

Many operating systems have been designed for standalone computer including, without limitation, Windows®, UNIX®, LINUX®, Mac OS, IBM VM and MVS, etc. Each of these operating systems have many common features, but all are tied to a standalone computer. However, as more and more people through out the world become wired to networks such as the Internet or a global information infrastructure or highway, operating systems need to keep pace.

Although many operating systems have been disclosed, there is a need in the art for an operating system distributed and resident on a network where remote computers with minimal resources can access and utilize network resources to accomplish user tasks without having to purchase, store, update, upgrade and maintain the latest hardware and software.

### SUMMARY OF THE INVENTION

The present invention addresses these needs by providing a distributed operating network system including a server system, remote digital processing units (DPUs) and a network interconnecting the server system with the remote (rDPUs) where the rDPUs include a kernel of the operating network and only sufficient resources to store the kernel and control extensions for applications and their associated routines; to interact with the kernel and to attach to the network. Of course, the remote DPUs will also include peripherals and other necessary hardware for full functionality. The server system includes at least one supervisor server and a plurality of support servers; each server, supervisor or support, having digital processing capabilities, memory, buses, peripherals, mass storage devices, communication devices and other hardware. Each server also includes software to support network communications such as login routines and the like. Although each server can include the operating kernel and all other extension to support full operating system capabilities, for security reasons, it is preferably that the support servers be designed simply to receive agents and execute the received agents. In this way, users having malicious intent will not be able to access information from the support servers, because the support servers will not contain a fully operational operating system. The server system also includes an application subsystem which can include one or more libraries of application software, a user registration subsystem, a user verification subsystem, a accounting/billing subsystem, and other subsystems to promote distributed computing and asset sharing among the DPUs connected to the network.

One feature of this invention is that all computers in the operating network (sometimes abbreviated herein as OpNet) will include a copy of the same OpNet kernel. By operating network, OpNet, the inventor means an “operating system” which tailors its size and needed components to a user's requirements at a remote site. The OpNet is designed so that each remote DPU contains locally only the kernel while all other software needed to support the remote DPU is downloaded from the network at boot-up. Although, each remote DPU can opt to have resident additional software.

At boot-up or restart, each remote DPU is identified and verified by user verification routines residing on the OpNet either remotely or on the server system. When a remote DPUs selects or accesses an application program the user identifier information, application information and time/date information is forwarded to the billing subsystem for tracking and invoicing. Each DPU at boot-up will be able to utilize any application on the network by selecting the application from one or more pull down menus. Once selected, the server system control extensions for the application along with all associated files to link the application to the requesting DPU pre-configured to DPU's hardware environment. When the user activates the application or any application, time/date information is forwarded to the account/billing routines for tracking and invoicing purposes. While the application is active (open) in the remote DPU, the user is charged. When the application is inactive (closed), the billing system receives an inactive statement and charging is suspended until the application is reactivated (re-opened). The billing system can also be designed to suspend charging when an application is left open for a period of time without user activity.

The OpNet provides different charging formats depending on the type of application usage the user desires. Thus, if the application is one the user uses routinely, then the application will be tagged resident so that either an environmentally tailored extension of the application resides permanently on the remote DPU or a tailored extension of the application is automatically downloaded from the network at boot up.

The present invention also provides an operating network including a kernel, an application repository, a repository of dynamic routines needed by a given application for a given remote DPU to execute the application on the given remote DPU, communications software, a user information database, user registration, identification and verification routines, user accounting/billing routines, user application usage routines and dynamic response routines for automatically tuning the operating network, globally, locally or remotely.

The operating network is designed to be distributed over all computers attached to each other over a network. Each computer in the network will include a common kernel and communications software, but only the server system will include other network libraries. However, the remote can include additional routines for constructing agents to be forwarded to support servers that are only capable of executing such agents and time/date routines for monitoring application usage which is forwarded to the accounting/billing system. User DPUsr can obtain needed application software from the network being assured of the most current software version and the most robust configuration for the user's DPU.

The present invention also provides methods for implementing the operating network system of this invention including the steps of installing the kernel and communications hardware and software onto each DPU connected to the operating network, installing the full operating network on at least one supervisor server of the server system; connecting the remote DPUs and the server system over one or more networks; interacting with remote DPUs; downloading user desired applications links; and tracking application usage by each remote DPU for accounting and billing purposes.

### DESCRIPTION OF THE DRAWINGS

The invention can be better understood with reference to the following detailed description together with the appended illustrative drawings in which like elements are numbered the same:

FIG. 1 is a block diagram of the basic structure of the OpNet of this invetion;

FIG. 2 is a block diagram depicting remote DPU internal structure;

FIG. 3 is a block diagram depicting the operating network structure;

FIG. 4 is a block diagram depicting the basic procedural workings of the OpNet;

FIG. 5 is a block diagram depicting the standard usage procedure of the OpNet;

FIG. 6 is a block diagram depicting the installation procedure of the OpNet;

FIG. 7 are a block diagrams depicting the OpNet detailed server structure;

FIG. 8 is a block diagram depicting the OpNet detailed remote DPU structure;

FIG. 9 are a block diagrams depicting network connectivity of the OpNet;

FIG. 10 is a block diagram depicting remote DPU to network communications;

FIG. 11 are a block diagrams depicting personal communications on network;

FIG. 12 is a block diagram application compatibility with the OpNet;

FIG. 13 are a block diagrams depicting program execution;

FIG. 14 are a block diagrams depicting user storage cohesion; and

FIG. 15 are a block diagrams depicting main storage expansion.

### DETAILED DESCRIPTION OF THE INVENTION

The invention has found that the operating systems currently being used are limited as more and more people become wired to global information infrastructures at higher and higher bandwidth. The present operating system are mainly computer resident and only somewhat multitasking. The inventor has therefore designed an operating network where each user computer, DPU (member computer) connect to the operating network includes an individual copy of the OpNet kernel and communications software for communication over a connecting network. All other desired applications are simply obtained from the operating network on a need basis where the user is billed only for his usage or in any other manner supported by the operating network and acceptable to the user. Of course, the user can opt to “acquire” an application so that it is permanently resident on the user's computer, but such acquisition would still be use-based so that the user would not be faced with upgrades or tailoring to the user's particular computer.

The present invention, therefore, broadly relates to an operating network including a common kernel, remote computers, a server system and a connecting network. The kernel includes only those routines needed by each member computer for supporting sending and receiving data and/or data streams for processing unit(s) associated with each member site, a graphics user interface for supporting user interaction through display devices such as monitors and input devices such as keyboards, voice activated devices and pointing devices, windowing software for supporting menus and menu selection and communications software for attaching to and communication with the operating network over the network interconnecting the member sites and the server system. The remote computer can be any user device that supports software execution and network communication such as a personal digital assistant (PDA), a personal computer (PC), a mainframe, a distributed or networked computing environment, or any other device supporting software execution and user interaction. The server system includes at least one supervisor server and at least one support server. The supervisor servers are fully configured servers including the kernel and a complete associated operating software for upgrading all applications and dynamic routines in the repository, upgrading all DPU configuration profiles for optimized DPU downloading and DPU performance of downloaded application software, adding to the repositories, performing accounting and billing functions, network optimization, networking upgrading, user identification, registration and verification, etc. Although the support servers can also be fully configured as a supervisor server, for security reasons, it is preferred that the support servers are limited only in the sense that they are capable of receiving and sending information and executing instruction associated with received agents. Thus, if a user at a member site selects a new application software package, the member site constructs an executable agent including the member site address and the software program request with needed dynamic routines to operate within the member site's configuration. The support server then executes the agent and upon completion forwards the agent back to the member site with the application software and needed dynamic routines. A record of this transaction is also available to the account/billing system.

The present invention also relates to an interactive, distributed operating network including member computer interconnected via one or more networks where each member computer (any type of device capable of storing and executing software instructions) has an operating kernel installed thereon and communications hardware and software for interacting over the networks. The network also includes application software repositories and repositories of all dynamic routines needed by the application to function in a given hardware environment, e.g., Intel® processors, Motorola® processors, Sun Microsystem processors, or any other processor and repositories of peripheral drivers.

The present invention also relates to an interactive, distributed operating network for accessing applications including a operating network distributed over all member computers and member servers where each member computer includes a kernel capable of communication with processors, memory and mass storage devices, capable of communication with the networks and capable of accepting routines to support application and peripherals, where some servers are supervisor servers and some servers are repository servers and where a user interacting with a member computer has direct access to software and hardware available on the network and where the user is charged on an actual use based basis for all applications along with a one-time or monthly network access fee.

The present invention also relates to a method for distributed and cost sharing use and support of application software and remote site hardware including interconnecting member computer and member servers with one or more networks using an operating network of this invention and interacting with the network to gain access on a use based billing format to software and hardware available on the operating network.

The present invention also relates to a method for installing an operating network of the present invention including installing a kernel on each member computer, converting any current application on the member computer to an operating network compatible version or downloading an optimized replacement application, connecting each member computer to an interconnecting network, and interacting with network to gain access to application software and remote site hardware on a use-based billing format where each application software selected will be downloaded to the requesting member computer optimized for the member computer along with any dynamic routines needed to interactive with the kernel and associated peripherals.

The present invention also relates to a method of adding a computer to an operating network of this invention including running a setup program to determine a hardware configuration of the computer and poll the computer for application software, removing any pre-existing operating system, application software with associated dynamic routines and peripheral support software, installing a kernel of the operating network and only the necessary software to utilize attached peripherals in an optimized manner, optionally adding communication hardware and software to support connection to one or more networks, connecting the computer to at least one network and registering the member computer with the operating network in a secure manner for accounting and billing initiation.

### Backward Compatibility—Applications Constructed Using Other Operating Systems

The present invention handles compatibility problems when a computer is added to the network by either converting the application to a compatible form or replacing the application with a compatible form optimized for the member computer. Previous to installing the Operating Network on a remote DPU (a remote computer), the user may have earlier purchased application software residing on the DPU. Having already purchased these applications, they may still be used with the Operating Network. Either emulators will be supplied to the remote DPU to run the non-compatible applications that are left over from previous operating systems or the operating network will simply replace the existing application with compatible, system optimized application versions, with the later being preferred.

The installation software will perform the following tasks during system loading and configuration:

1. Allow the user to select the pre-existing applications to be retained from an Icon or List Selection;

2. If the selected pre-existing application is currently supported by the Operating Network, then the user will have the option of installing an emulator or overwriting the selected pre-existing application with a compatible, optimized version;

3. If the selected pre-existing application is not currently supported by the Operating Network, then software will download an emulator for the network so that the application can be run by the kernel;

4. While being processed, the kernel will register that the selected pre-existing application is not compatible with the Operating Network;

5. Each time the application is launched, the time/date system will initiate the timing mechanism for emulator use;

6. After usage of the application is finished, all saved files or information is sent back to user's account on the server, the application is closed, all information concerning timed usage is registered into account information, and the emulator shuts itself down; and

7. The user may have the option to hold the emulator in the backup storage for later use of same or other applications.

### Personal Communication on Network—Multimedia and General Communication Between Users

Within the framework of the Distributed Operating Network, users can communicate with any other user or member computer on the system, provided that the user or member site is allowing user communication and asset sharing. The communication formats available include, without limitation, Text Chats, regular phone lines, videophone, VR or any other communication format or protocol supportable over the interconnecting network. Additional features will include voice or video mail, e-mail, and communication blockers, which permits user and site privacy.

1. Within the Kernel and extended Kernel of the DPU, certain user codes and communication protocols exist that offer the ability to contact the other users on the server network. These features hold the users identification and allow contact to the intended recipient.

2. A “Communication” listing is selected from the graphics user interface (GUI) that allows the user to search for the intended recipient by name, company, address, etc. Once the recipient is selected, the style of communication is selected (if the recipient does not have that mode of communication, an error message will return requesting the user to specify another style). For commonly contacted recipients, a “favorites” listing will be offered.

3. The connection request is broadcast on the network as a stream or agent containing all information about the sender (user codes, etc.), communication style and recipients name and/or address.

4. The operating network receives and translates the request. Before contact, the operating network will recall and check recipient's capabilities and instructions in communication responses. If recipient requests that calls be blocked, then the sender will receive a message that the user or site is currently not accepting communications. If the recipient is setup with a messaging service, then the message is left with the service and the sender is informed of same. If the recipient does not have the correct media, an error message will respond to the sender so the media request can be corrected or the network can automatically correct the media and send a message to the sending informing of same and update the recipient's profile in the sender user profile list so that following communication will automatically send in a correct format.

5. When the request is announced to the recipient, the operating network will offer information about the sender and whether the request will be accepted. If not, the sender will receive a message stating the refusal by recipient.

6. Once all member information is verified and if the request is accepted by the recipient, the operating network connects the user through the designated communication style that was selected. The server submits the appropriate application to the Extended Kernels of both personal computers and tells the sender the call has been connected.

7. A timing mechanism is activated that monitors the duration of the call. Once the call has been disconnected, the time duration is inputted into the user's accounts for member or client billing purposes.

8. After disconnection, the inter-DPU communication application will remain in temporary memory, but may be a mass storage device. If storage is full, its memory will be written over as if empty. This allows for quicker access to applications that are used frequently as with all other items contained, saved or stored in temporary memory.

### Operating Network Detailed Structure (DPU)—Detailed Workings Within Member Site Computer

The essential contents existing in the personal computer component of the Distributed Operating Network include the following:

1. The Kernel—entails all active communication to the CPU, including the interpretation of interactivity with the GUI application, hardware drivers, all driver commands to the extended hardware (CDRom, printers, scanners, etc.), multi-process scheduling to the CPU(s), server request protocols, encryption/decryption controls, user identification and other basic system functions. The kernel also maintains all necessary coding to sustain cohesion between the DPU and server components. The Kernel also keeps all information on the user and his/her habits and preferences (i.e. remembers folder locations for GUI, what applications are used most frequently, desktop color styles, etc.).

2. The system can also include an Extended Kernel which can be used to maintain certain GUI application feature and/or requirement or other advanced features or user preferences to better enhance routine performance, not within the backup storage.

3. Backup storage—Although, essentially a small temporary memory based drive for maintaining integrity of the system in case of network failure, this facility will contain the server-connected applications and important files of the user. Depending on the size of the backup storage, the applications and files will be maintained consecutively until storage is full. Reasons for this is for quick reactivation of commonly used application and accessed files. This component will be treated like a “RAM spooler” in terms of memory allocation. Once full, the storage will be reset, in a certain manner, starting from the beginning and write from the beginning as if the memory is empty. Applications are ‘recycled’ when reused, changing their position in the line-up. This increases the chances that it will still be in memory to be quickly reactivated. An appropriate term for this technique would be “Cyclical Storage”.

### Operating Network Structure—How the Operating System is Structured

What the Distributed Operating Network has essentially done is slice an operating system along a decided border, and split the elements of it across the overall expanse of the Internet, client/server medium.

1. The DPU side—The DPU structure contains the essential elements that define an operating system. These features must exist to function. Due to the split nature of the Operating Network system, the essentials become slightly broadened. The elements on the DPU include:

a. The Kernel—the heart of the system. This is the part that speaks directly to the hardware. In a Distributed Operating Network, an “extended” kernel approach can exist to hold information needed for conversation with the server (advanced user preferences, settings, codes, etc.).

b. Backup storage—essentially a small temporary memory based drive for maintaining integrity of the system in case of network failure. Applications and files are temporarily stored here for easier access and to promise no downtime due to network failure.

c. Encryption/Decryption Control—technically exists within the Extended Kernel. Controls the security of the information being passed between the DPU and server. All communication between the two is coded during transmitting.

d. Necessary ID and hardware drivers—other essentials that fall into the Extended Kernel. This includes the drivers installed for all hardware connected to the DPU, such as printers, monitors, etc. The ID's are the account information that let the user contact the server to access all their storage. Without these, access will be denied by the server.

2. The Server side—The server side contains the softer elements of the operating system; softer meaning more like extensions upon the main essentials. To be sure, these have great necessity as well (like the drive filing system), but for the best performance of a Distributed Operating Network system, these fall into the server category.

a. System Communication Agent—The active response program on the server. The agent is also serves as the encryption/decryption control. The agent waits for requests from the user, decrypts the tasks requested before entering the CPU.

b. Drive filing system and main storage—As with any standard operating system, the server is the main storage facility of the system, and maintains the filing system within the users' accounts. Files that have been accessed will be set in the backup storage, but not maintained in any true filing system.

c. All Software Applications—This feature of the Distributed Operating Network stores all applications that are available through the Distributed Operating Network. All applications available for the system are accessible to the users. With a timing mechanism associated with each application for accounting purposes, users no longer have to acquire software applications directly, but can rent desired application for a certain length of time. When applications are launched, timing begins; when the application is exited, timing stops. All timing records are placed in the user's account for user accounting and billing purposes. All work done on any application is saved in the users filing system and coded for the application that it was developed with.

### User Storage Cohesion

To best allocate the space existing on the Server Network, each user's Main Storage Unit should be tightly bound together, without gaps overlapping between Storage Units. As well, this enhances the performance of the server and speed of access.

1. During random times of inactivity, the DPU kernel will send a request to scan the user's Main Storage Unit for any gaps or fragments of storage that are delinquent.

2. The Storage Defragmentation tool (stored in the application portion of the server) will be activated and review the intended Main Storage Unit based on the user codes received. This tool is independently run by the system, but a user requested call can be made to activate this application and monitor its progress.

3. Once the application is executed, it will search across the Server Network outside the users Main Storage Unit parameters and scan for the user codes that it was given. If no exterior matches are found, the Defragmentation tool will shut itself down and wait for its next assignment.

4. If any user codes outside the parameters are discovered, the Defragmentation tool will scan the length of the memory block, locate a suitable position for it in the Main Storage Units parameters and transfer the data. Because of non-concurrent storing of information from many users, areas within the parameters may be used by different users. If so, the Defragmentation tool will transfer this data to an empty space elsewhere on the server and then transfer over the intended data.

5. Once all transfers have been completed or CPU activity on the DPU increases, the Defragmentation tool will shut down and will wait until its next assignment.

6. Although independantly run, the Defragmentation tool will maintain a log for service on the Server Network, the by-product of this being early alerting if critical situations occur or server memory itself is becoming low. The defragmentation tool maintains the constant cohesion of memory within each user's Main Storage Unit, offering a stable environment and better performance.

### Main Storage Expansion—Unlimited and Users Expandable

When a user's storage abilities have been exhausted, the Distributed Operating Network offers the feature of adding more storage. There are no immediate limitations to the amount that a user can expand.

1. The server recognizes that the user's storage space has been depleted when there is no more blocks of memory that contain that users identification codes on the Server Network.

2. A message is sent to the user letting them know that their designated Main Storage Unit is full. The option to expand their Main Storage Unit is offered. If the option to expand is declined, the system will cancel the announcement and wait for the next command. If a process that requires additional space is later attempted, the system will then offer the expansion offer again.

3. If the expansion option is selected, the system will request information from the user. This information will include:

a. Amount of additional persistent storage space requested.

b. Verification of the intended account to bill.

c. An authorization code is required to process and implement storage expansion (this is a user-defined code implemented at initial installation).

4. Once completed, all information is sent to the server. If the information is not valid, a message will be sent back to the user declaring that the process terminated in an error state. The information will be displayed to the user to make corrections. The process can be cancelled if desired.

5. Once the server has verified all information, a Storage Expansion Program will search across the Server Network for the largest blocks of space to add to the user's Main Storage Unit, until the amount of storage requested has been satisfied. The Storage Defragmentation tool will adjust the storage correctly to keep all user-coded storage connected physically on the Server Network (explained in User Storage Cohesion diagram).

6. Once the Main Storage Unit has been completely expanded all the data of this request is sent to the billing registry. Based on amount of storage expanded, the user will be billed upon this purchase of space. All account information will be saved concerning all storage transactions. Once the procedure has been completed, a message is sent to the user confirming the expansion was successful.

Reference is now drawn to the Figures which are included for purposes of illustrating different aspects of the operating network of the present invention and are included for illustrative purposes and not to limit the scope of the invention.

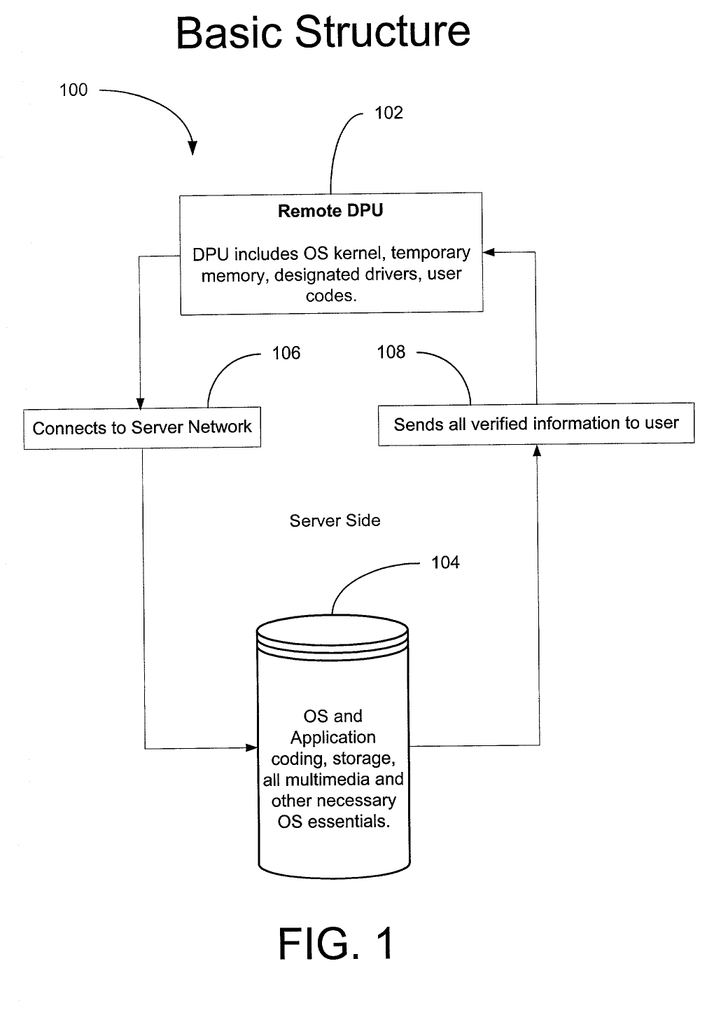

Referring now to FIG. 1, the basic and overall design of the operating network the present invention, generally 100, is shown to include a remote DPU 102, a server subsystem 104 and network connection 106 and 108 interconnecting the DPU 102 to the server subsystem 104. Of course, the DPU can be any device capable of executing instructions, receiving and transmitting data and interacting with a user. The DPU 102 include an operating system (OS) kernel, memory such as RAM (for flash or temporary storage), designated drivers, user codes and desired peripherals. The server subsystem includes at least one supervisor server that has a full OS version resident thereon, all Application codes, storage, all multimedia and other necessary OS essentials.

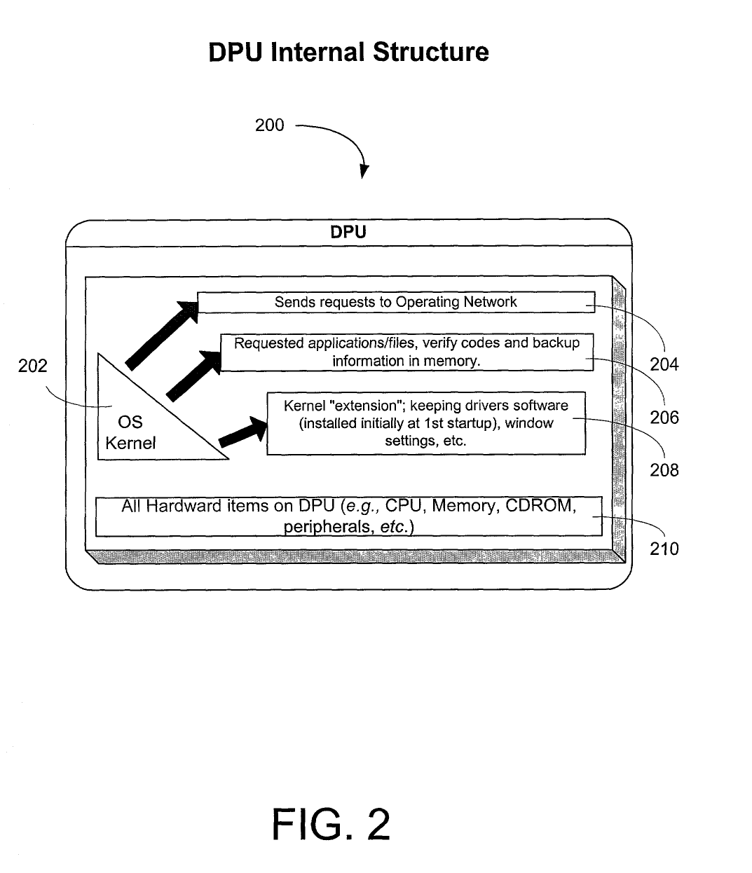

Referring now to FIG. 2, a detailed description of a remote DPU internal structure, generally 200 is shown to include an OS kernel 202 which is responsible for OpNet communications 204; for requesting and receiving application/files, verifying codes and maintaining backup to internal hardware 206 and for accessing kernel extension 208. The kernel 202 is also responsible for “operating” the internal hardware 210 of the DPU 202 from routines in the kernel 202 and any extension 208.

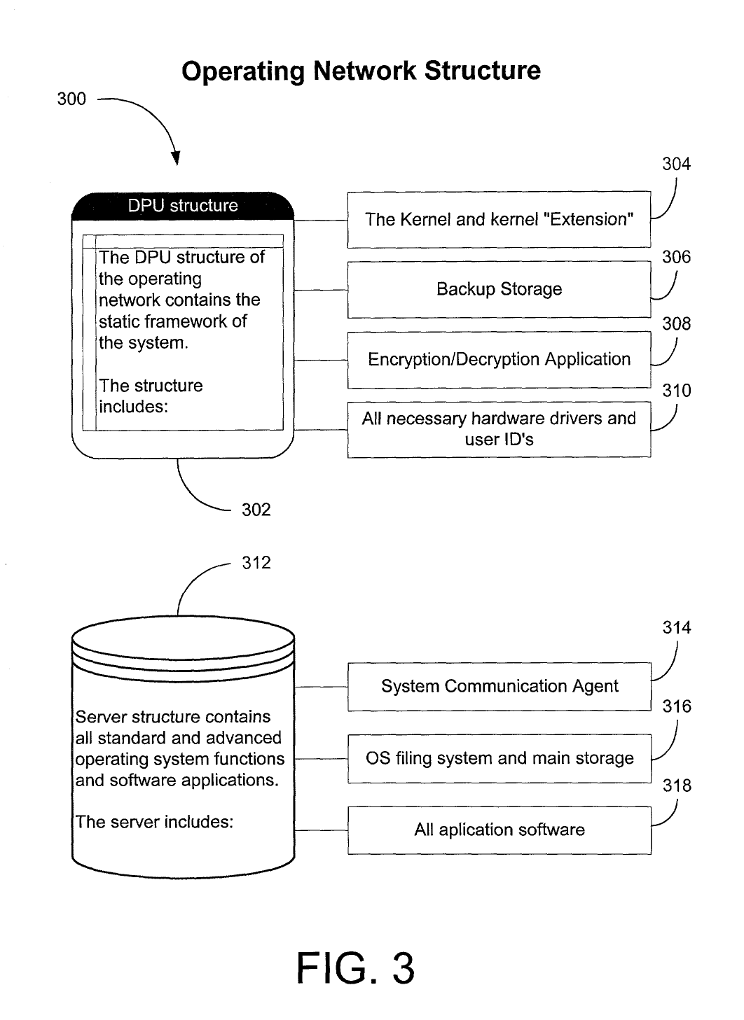

Referring now to FIG. 3, an Operating Network Structure, generally 300 is shown to include a basic DPU structure 302 of the operating network implemented at the DPU level which includes an Extended Kernel 304, Backup Storage 306, Encryption/Decryption routines for Applications 308 and necessary hardware drivers and user ID's 310.

The operating network structure at the server level 312 includes listening agents 314, drive filing systems and main storage 316 and application software 318 which includes necessary dynamic routine and optimal system configuration routines and/or data.

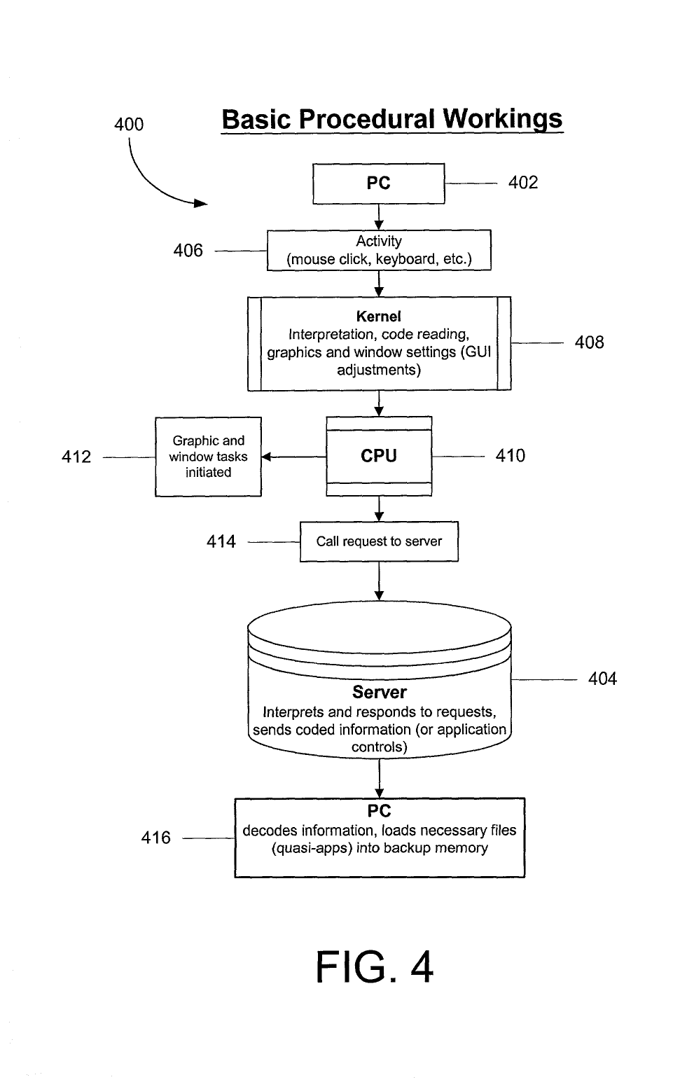

Referring now to FIG. 4, the basic procedure working of the operating network of the present invention, generally 400, is shown as a block flow diagram outlining a remote DPU (any remote digital processing unit) 402 interaction with a server subsystem 404. The DPU 402 includes user interactive peripherals 406 such as a mouse, keyboard, voice command or the like. The user enters a request or requests a task to be performed by the DPU which is interpreted by an operating network kernel 408 that converts the request into machine executable instructions and forwards the instructions to a CPU 410 which updates GUI information 412 and forwards 414 the request over the network to the server subsystem 404. The server subsystem 404 determines the nature of the request and forwards 416 the requested information to the remote DPU 402 which then proceeds completing the user's request. If the request is to use an application, then the server subsystem would bundle the request application control and associated dynamic linked programs (e.g., DDE, DLL, so files or the like) designed for the user's DPU and forwards the application control to the remote DPU for temporary use and storage. The server subsystem also initiates the billing subsystem so that the user is billed for using the application. Timing can either be performed at the server via periodic communication with the remote DPU or the remote DPU can maintain usage information and upload the information on some predetermined periodic basis such as daily. Of course, the information on the remote computer is backed up both locally and over the network in case of a crash to minimize information loss.

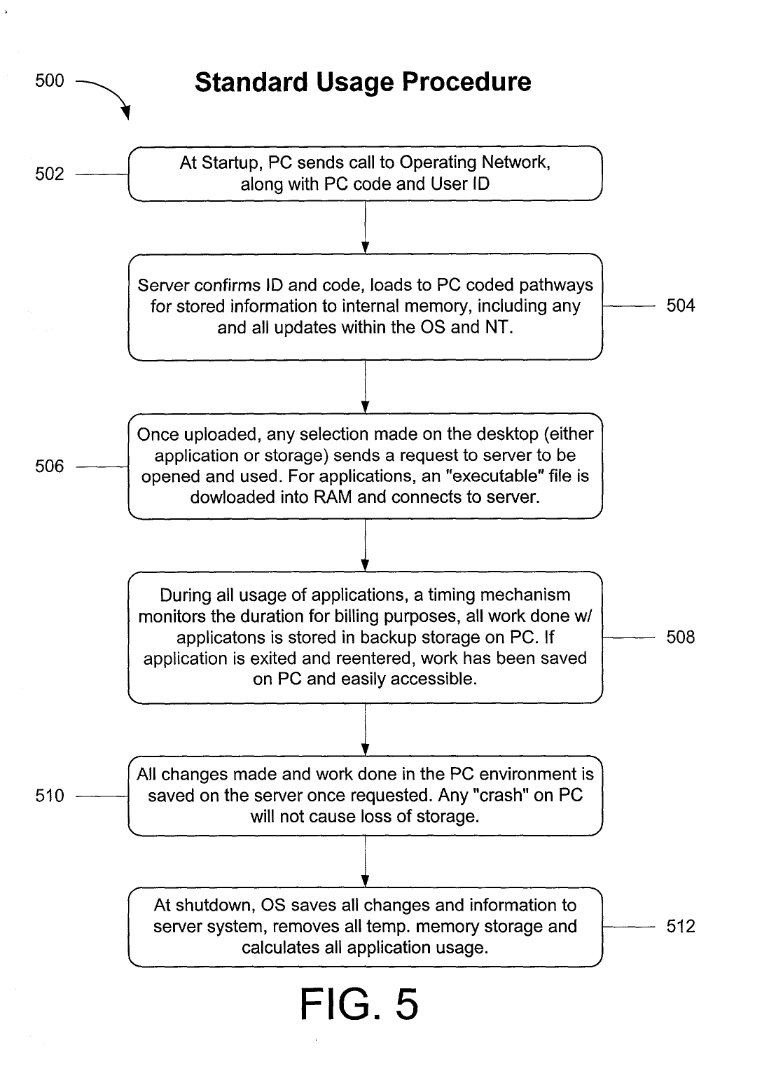

Referring now to FIG. 5, a flow diagram depicting a DPU startup process, generally 500 is shown to include a startup step 502 where the DPU at Startup sends a call to Operating Network which includes a DPU code and User ID. The process 500 also includes a server confirmation step 504 where a server confirms the user ID and the DPU code, downloads to DPU internal memory via the DPU code information including updates to the OS, network and any resident applications. The process 500 also includes a DPU request step 506 where once the startup download is complete, any selection made on the desktop (either application or storage) sends a request to server to be opened and used. For applications, an “extension” file is downloaded into temporary memory and connects to server. The process 500 also includes an application timer step 508 where during all usage of applications, a timing mechanism monitors the duration for billing purposes, all work done with applications is stored in backup storage on DPU. If an application is exited and reentered, working files and application extensions are saved on DPU for easy accessible. The process 500 also includes a server save step 510 where all changes made to data files and work done in the DPU environment are saved on the server periodically or upon request. Any “crash” on DPU will not cause loss of stored data on the servers. The process 500 also includes a shut down step 512 where at shutdown, the OS saves all changes to data files (an new files as well) and information to server system, removes all temporary memory storage and calculates all application usage for billing purposes.

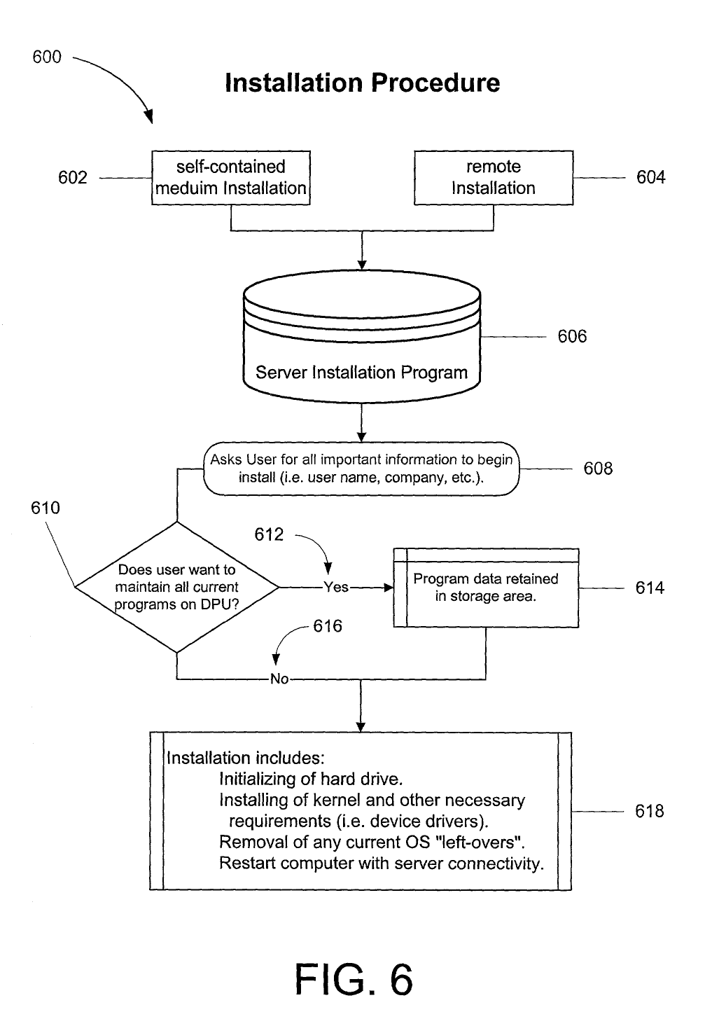

Referring now to FIG. 6, an installation method, generally 600 is shown to include either a self-contained medium Installation 602 (e.g., CD, flash-card, or the like) or a broadband Installation 604 (e.g., Browser, FTP or the like). Both installations 602 and 604 attach to the OpNet and the installation is executed by a Server Installation Program 606. The installation programs queries the user for all necessary identification information (i.e., user name, company, billing address, e-mail address, WHAT ID, etc.) prior to software install in an information request step 608. The user is then asked where all current programs will be maintained on the DPU in a maintain current programs conditional step 610. If the user wants to maintain existing programs, then control is transferred along a YES branch 612 to a store program data in storage area step 614. If the user does not want to maintain existing programs, then control is transferred along a NO branch 616 to an installation step 618 which includes (1) Initializing the hard drive; (2) Installing the kernel and other necessary software (i.e., device drivers); (3) Removing the current operating system (OS); and (4) Restarting the computer with server connectivity. The installation procedure can also offer the user the option to replace all non-compatible or non-optimized application programs with OS compatible and optimized applications. These upgrade applications would be free of charge to the user.

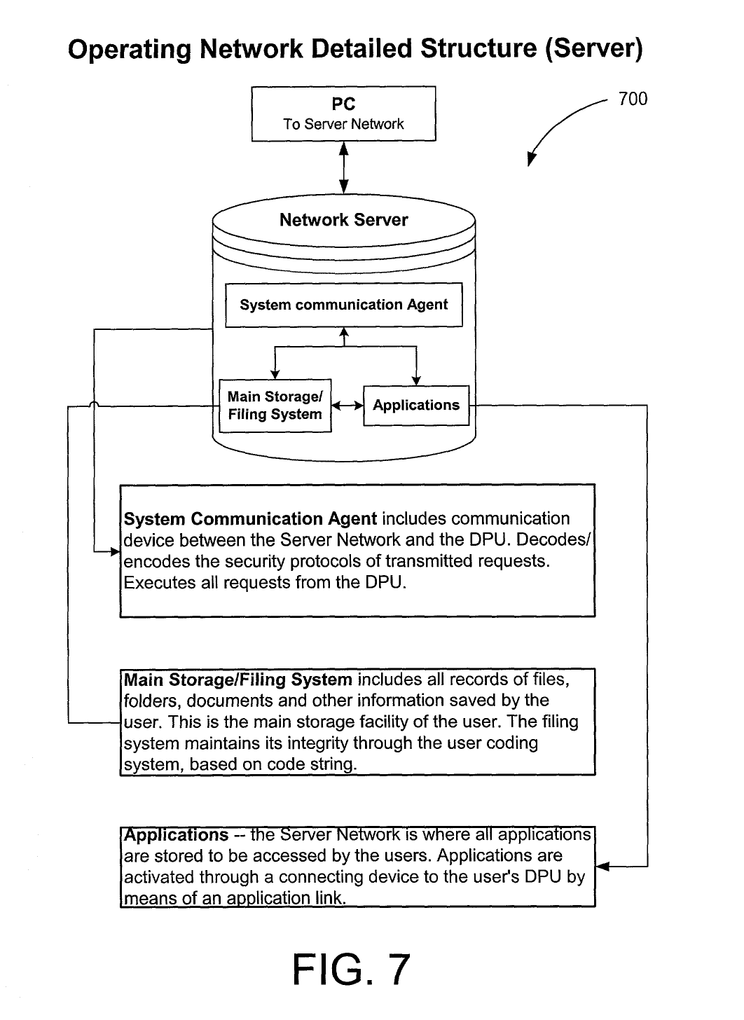

Referring now to FIG. 7, a detailed structure of the OpNet at the server level, generally 700 is shown to include a DPU 702, a DPU-to-network communication path 704 and a limited network server 706, where the communication path 704 leads to any network servers associated with the OpNet. The network server 706 includes a system communication agent and a decryption/encryption routine 708, a filing system 710 and an application library 712. The agent 708 includes communication hardware and software which listens for requests sent from the DPU 702 over the path 704 to the network server address device. The decryption/encryption routine 708 either decodes the requests from the DPU 702 or encodes the the response to the DPU 702. The filing system 710 includes all records, files, folders, documents or other information saved by users. The filing system 710 maintains integrity through a user coding system based on unique user code strings. The applications library 712 includes all stored applications available to users. The applications are activated through the path 704.

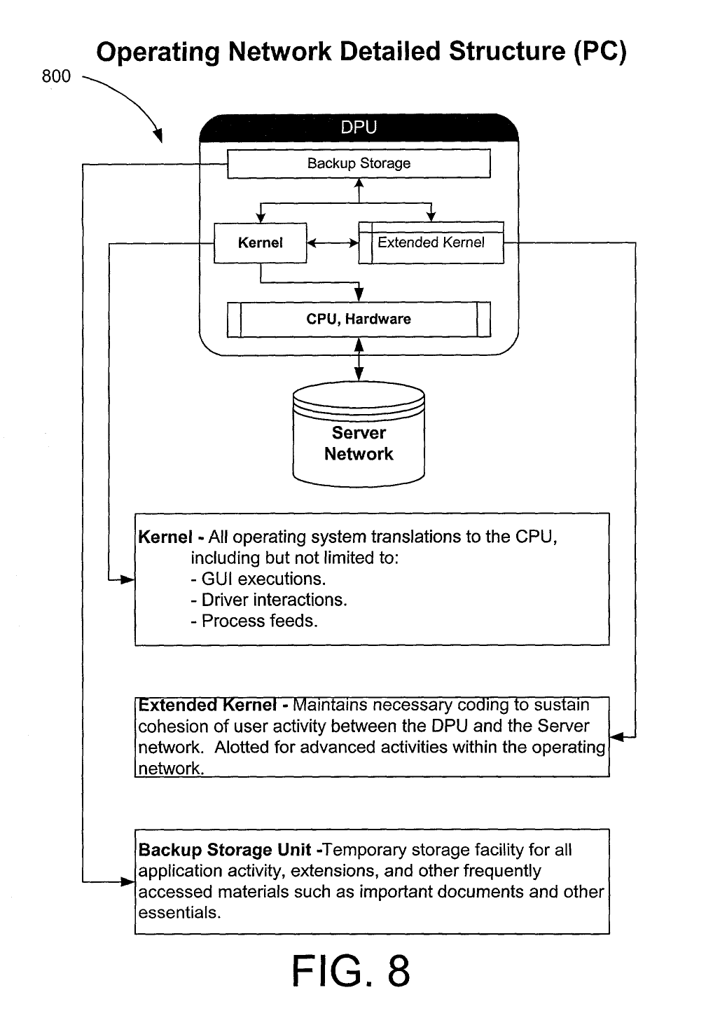

Referring now to FIG. 8, a detailed structure of the OpNet at the DPU level, generally 800 is shown to include backup storage 802, an OpNet kernel 804, an extended OpNet kernel 806 and a digital processing unit or CPU and other hardware 808, all in communication therewith. The hardware 808 is connected to a server network 810 via communication path 812. The backup storage device or unit 802 stores temporary copies of all application, extensions or other software used by the user at the DPU level. The kernel 804 includes all operating system routines to drive the digital processing unit and peripheral hardware associated therewith such as GUI operations, driver interactions and process feeds. The extended kernel 806 maintains all necessary coding to sustain cohesion of user activity between the DPU and the servers on the network.

To avoid unnecessary indirect jumping to server area then in-place local networks, a connection must be directly made for each in-place network to the operating network which can be accomplished by a direct connector between the in-place network and the kernel that allows opening/saving/running programs from the in-place networks. This connection can be done in two ways. First, a connector can be added to the “Extended Kernel” that allows direct access and is strictly read-only, using an interpreter to execute commands. Second, the current Hard Drive(s) on the in-place network can be treated by the Operating Network as another server port, allowing all programs that are necessary for the local network usage to be stored and used separately.

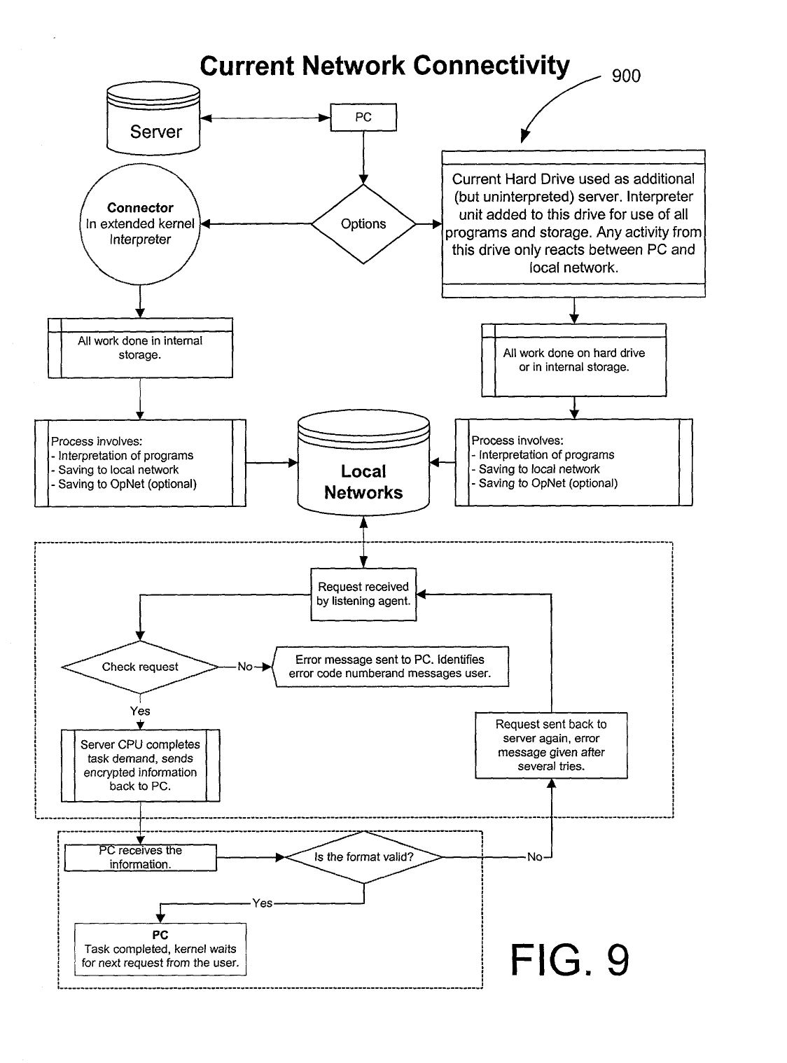

Referring now to FIG. 9, a network connectivity scheme involving a local network, generally 900 is shown to include a server 902, a remote DPU 904, a communication path 906 between the server 902 and the DPU 904. The scheme 900 has two optional implementations controlled by a conditional branch 908; a first implementation 910 and a second implementation 912. The first implementation 910 includes using an existing hard drive on the local network 914 which has a resident interpreter controlling all local operations. The processing is performed locally in step 916 and includes processes listed in process step 918. The process step 918 includes interpretation of programs, saving to local network computers or servers and optionally saving to OpNet. The second implementation 912 includes the use of a resident connector 920 added into the extended kernel. All OpNet operations are performed in internal storage in execution step 922 which involves a process step 924. The process step 924, like the process step 918 includes interpretation of programs, saving to local network computers or servers and optionally saving to OpNet. The process steps 918 and 924 all occur in a local network or networks 926. Requests then flow from the local network(s) 926 to an OpNet server 902 via communication path 928 to the server 902. The requests are received by a listening agent in a receive step 930. The received request is then processed in a conditional decryption step 932 where requests that are errant or incomprehensible are sent back along a NO branch 933 to the requestor with appropriate error codes in an error message step 934. If the request is decipherable and comprehendible, then the request is forwarded along the YES branch 936 to a server which executes the request, encrypts a response and sends the encrypted response back to the requestor in execution step 938. The DPU 904 receives the response in a DPU receive step 940 and tests the response for validity in validity test step 942. If the response is valid, then control is transferred along a YES branch 944 to a task completion step 946 where the DPU completes the task and the kernel waits for the next user request. If the response is invalid, then control is transferred along a NO branch 948 to a request retransmission step 950 with appropriate error message which is then treated as a new request in the receive step 930 with the added error message data. Concerning local in place networks, to avoid any unnecessary indirect jumping to server area then to local network, a connection is preferably made directly made for these current networks already in place. To do so, there is preferably a connector to the kernel that attaches these directly and allows for opening/saving/running of programs from these in place networks. This can be done easily in two ways. First, a connector can be added to the Extended Kernel that allows direct access and is strictly read-only, using an interpreter to execute commands. Second, the current Hard Drive on the system can be treated by the OS as another server port, allowing the programs that are necessary for the local network to be stored and used separately.

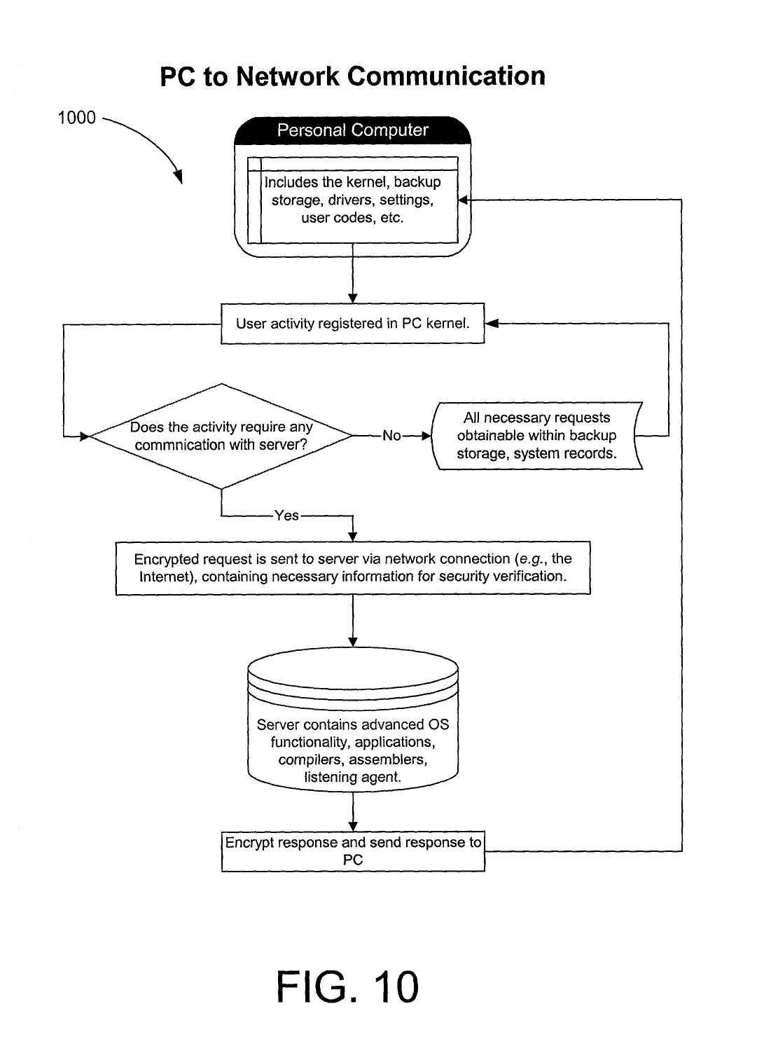

Referring now to FIG. 10, a basic scheme for DPU to OpNet communications, generally 1000 is shown to include a DPU 1002 including the kernel, backup storage, drivers, settings, user codes and other DPU software necessary for proper DPU operations and interaction with the OpNet. User activity is registered in the kernel in a registration step 1004. The activity is then tested in a conditional test step 1006 to determine whether the activity is executable locally or requires interaction with an OpNet server 1008. If the activity is locally executable, then control is transferred along a NO branch 1010 to local execution step 1012 and back to activity registry step 1004. If the activity requires OpNet communication, then control is transferred along a YES branch 1014 to an encryption step 1016 which encrypts the request and forwards it to the OpNet server 1008 for execution and return a response to the DPU 1002 in a return step 1018.

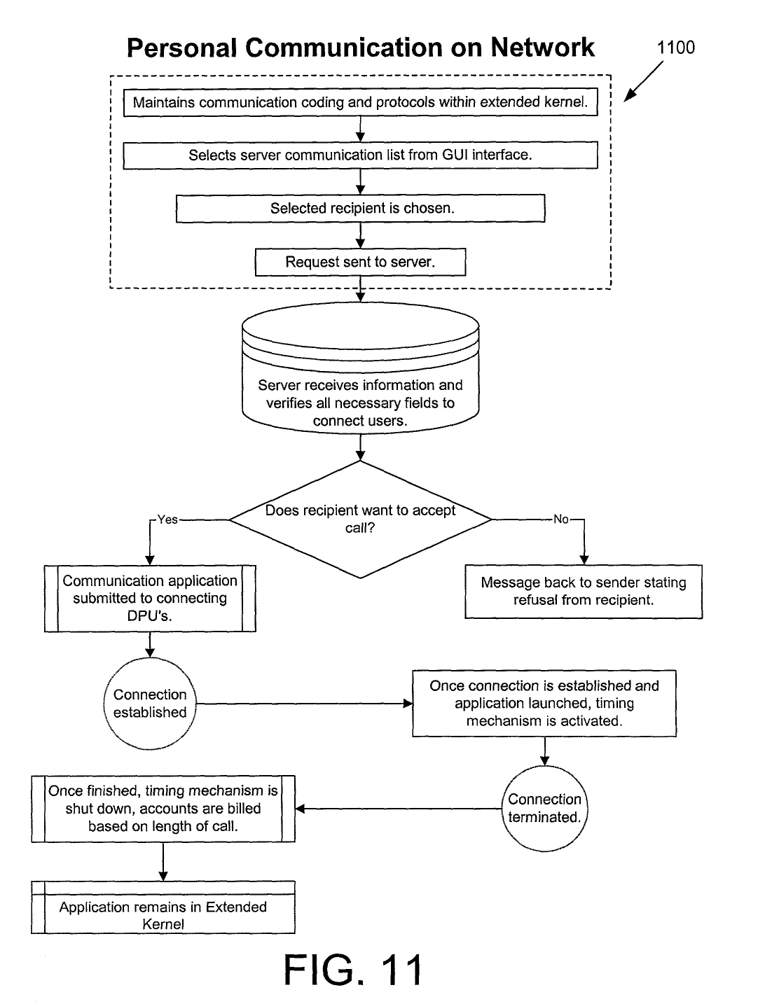

Referring now to FIG. 11, a scheme for personal communication on the network, generally 1100 is shown to include a maintenance step 1102 for maintaining communication codes and protocols within extended kernel. A user selection step 1104 where the user selects a server communication from a pull-down menu associated with the GUI interface. A user select recipient step 1106 where the user selects the desired recipient or recipients. A user request step 1108 where the user constructs and sends a communication or request to the desired recipient. The request is forwarded to an OpNet server and received by the server in a receive step 1110 where the recipient information is verified. The recipient is then notified in a conditional step 1112 to determine whether the recipient will accept the communication or call. If the recipient will not accept the communication or call, control is transferred along a NO branch 1114 to a message back step 1116 where a message is sent back to the sender informing the sender that the recipient is not accepting the communication or call. If the recipient will accept the communication or call, control is transferred along a YES branch 1118 to a communication application submission step 1120 where the recipient DPU is connected to the sender DPU via the network and a connection is established in a establish connection step 1122. Once the connection is established and the application is launched, a timing routine is activated in a timing activation step 1124. When the interaction between the sender and recipient is terminated, control is transferred to a connection termination step 1126 which causes the timing routine to stop timing and the sender account is billed based on duration of connection in a accounting step 1128. Finally, the activated application remains in the extended kernel in a application retention step 1130 for further used until DPU shutdown or until the user deletes the application.

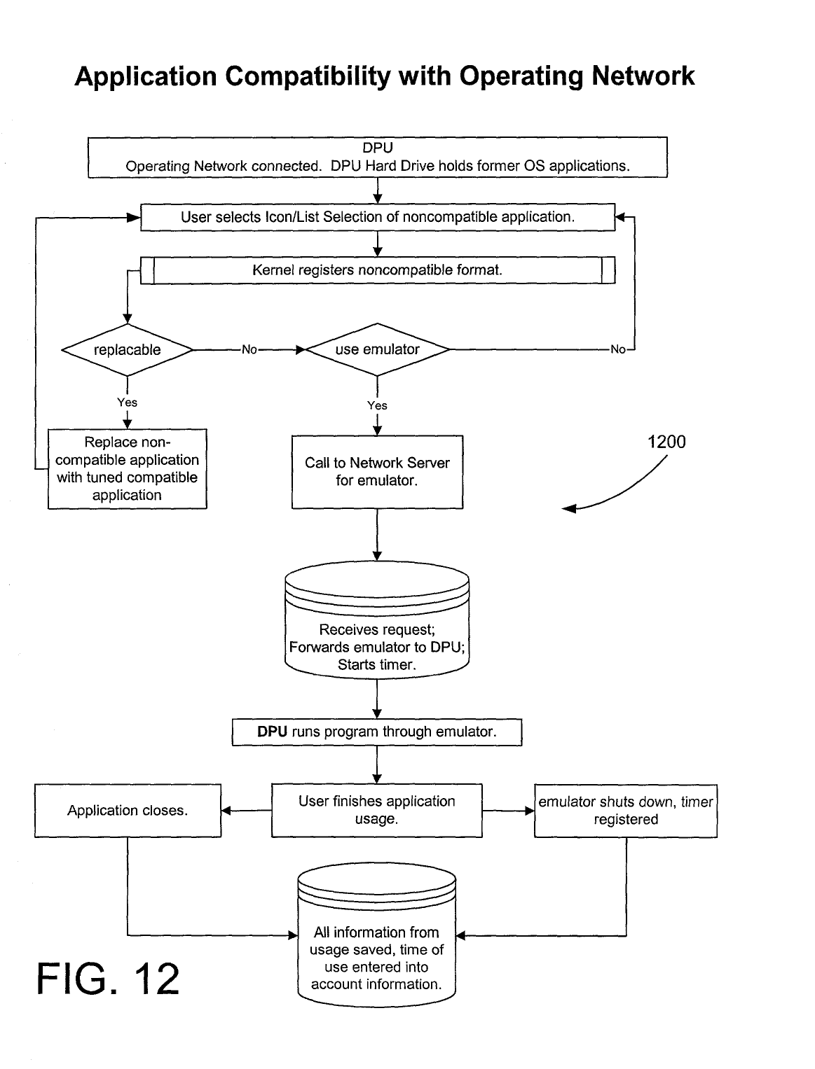

Referring now to FIG. 12, an application compatibility scheme, generally 1200 is shown to include an OpNet connection step 1202 where the OpNet is connected to a remote DPU and the DPU hardware holds former OS applications. The user selects from icon or a list of non-compatible applications in step 1204. The kernel registers the format of the selected non-compatible application in a registration step 1206. The application is then tested for replaceability in conditional step 1208. If the application is replaceable, then control is transferred along a YES branch 1210 to a replace application step 1212 where the non-compatible application is replaced by a tuned compatible application and control is returned to the selection step 1204. If the application is not replaceable, control is transferred along a NO branch to a conditional step 1214 where the user is queried as to whether the user desires the application to be run using an emulator in a emulator query step 1216. If the user does not desire an emulator, then control is transferred along a NO branch 1217 to the selection step 1204. If the user desires an emulator, then control is transferred along a YES branch 1218 to a server call step 1220 which creates a call to an OpNet server 1222. The server 1222 then executes the request, forwards the emulator to the DPU and initiates a billing timer in a server execution/timing step 1224. The remote DPU runs the application using the emulator in a DPU execution step 1226. When the user finishes using the emulated application in completion step 1228, the application closes in an application close step 1230 and the emulator is shut down and the timing routine is stopped in a emulator shut down step 1232. The resulting information is then forwarded to the accounting and billed subsystems on the server in a time usage retention step 1234 where the user's emulator usage will be billed to the user's account subsequently or immediately.

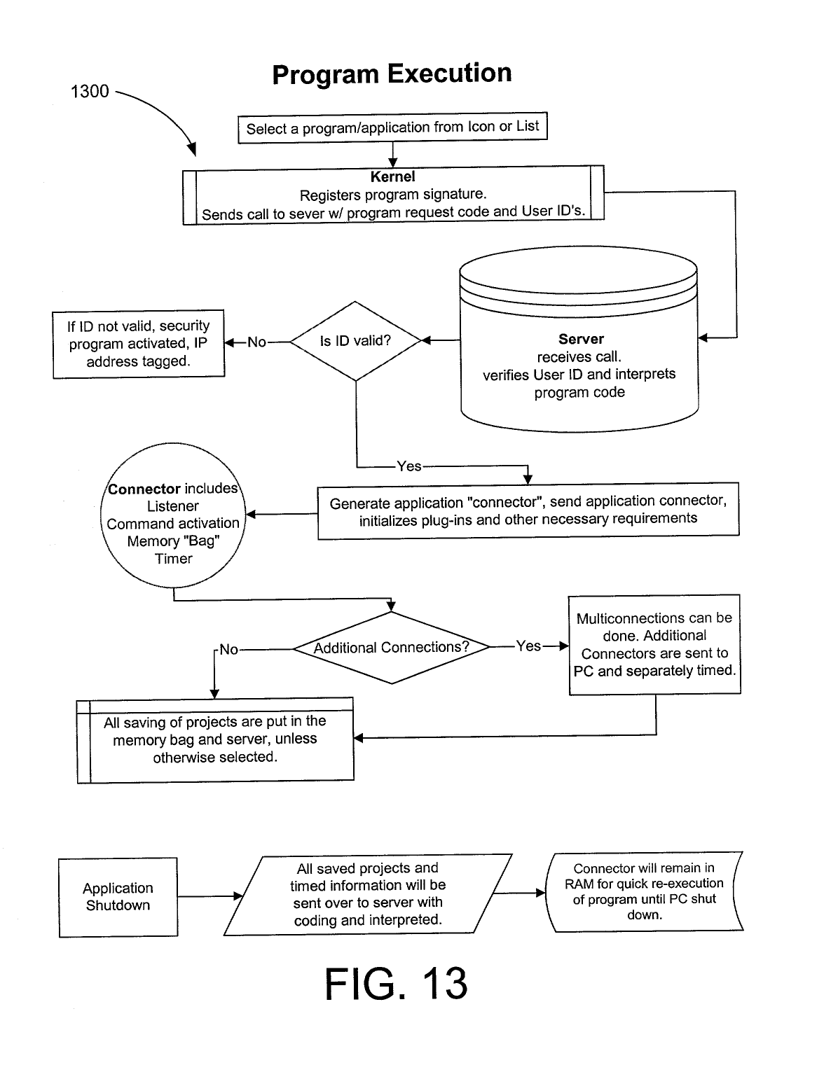

Referring now to FIG. 13, a basis scheme for program or application execution, generally 1300 is shown to include a user selection step 1302 where a user selects a desired application from an icon or a list. Once selected the kernel registers the program signature or identifier and user identification information and sends a call with the program request to the server in a registration/request step 1304. The request is received by an OpNet server which verifies user status and interprets the program code in a server call processing step 1306. The user ID is then tested for validity in a validity test 1308. If the ID is invalid, then control is transferred along a NO branch 1310 to a security step 1312 which activates the OpNet security programs and the IP address is tagged. If the ID is valid, then control is transferred along a YES branch 1314 to a generate application “connector” step 1316 where an application extension or connector is created and sent to requester with necessary plug-ins. The connector is established in a connector step 1318. The connector opens powerful ability to use both the DPU CPU and Server CPU strengths to complete tasks. Also, the connector can offer advanced multi-tasking capabilities or distributed processing capabilities. The connector includes a listener, command activation, a memory bag and a timer. The connector is then tested for additional connections in an additional connection step 1320. If additional connections are needed, then control is transferred along a YES branch 1322 to a multi-connections processing step 1324 that establishes additional connections and send the connectors to the requester and begins separate usage timers for each additional connection. Control is then transferred to a project save step 1326 where project data is saved in the memory bag on the requestor site and on the server unless otherwise selected. If no additional connection are required, control is transferred along a NO branch 1328 to the project save step 1326. Application shut down 1330 will cause all projects to be saved and stops all timers and time information is sent to server for accounting and billing processing in a save step 1332 and the connector(s) will remain in temporary memory for quick re-execution in a retention step 1334.

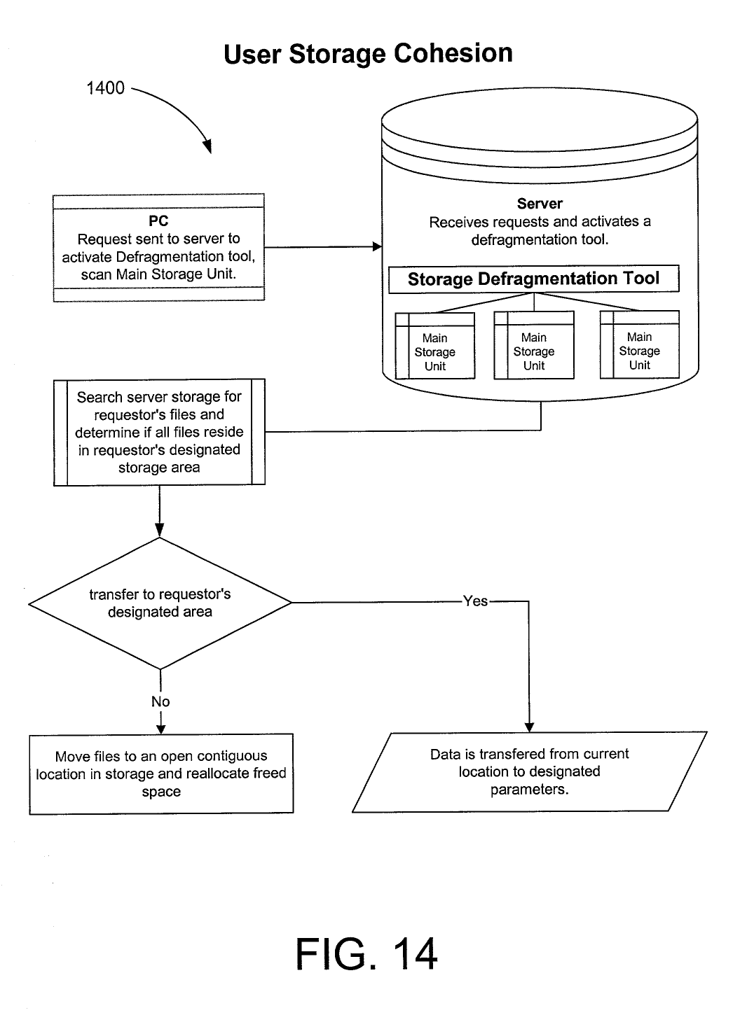

Referring now to FIG. 14, a user storage cohesion scheme, generally 1400, is shown to include a DPU request step 1402 which requests an OpNet server 1404 to activate a defragmentation tool and scan user main storage unit. The request is forwarded to the server 1404 which activates memory defragmentation in a defragmentation step 1406. The defragmentation tool searches all server storage for files bearing the requestor's unique OpNet ID in a memory search step 1408. If files are found outside the requestor's designated area, control is transferred to a transfer test step 1410. If the outside area files can be transferred into the requestor's designated area, then control is transferred along a YES 1412 to a data transfer step 1414. If there is insufficient storage space in the requestor's designated area, then control is transferred along a NO branch 1416 to a move all files step 1418 where all of the requestor's files are moved to an open contiguous storage location and the other file space is freed. Within the Server Network, a Storage Defragmentation tool must exist to maintain the integrity of each Main Storage Unit that exists on the servers. This tool would be used to keep all of the Storage Units contained in their own proximities and prevent crosslinking of memory.

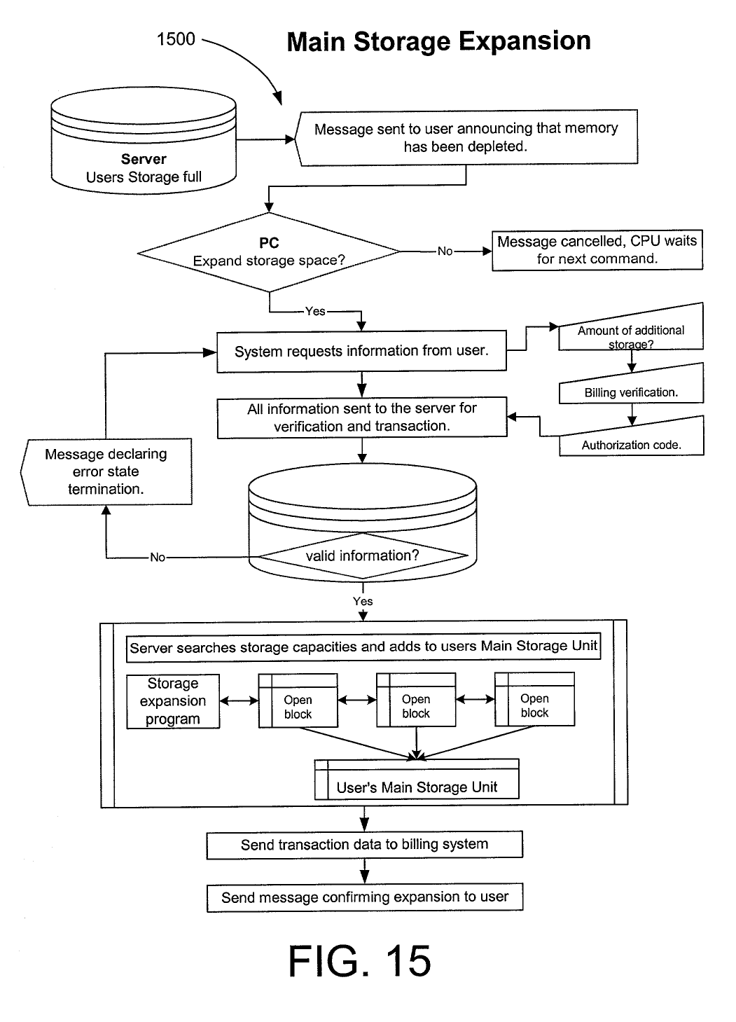

Referring now to FIG. 15, a scheme for user main storage expansion, generally 1500, is shown to include a server user storage full condition step 1502 which causes a message to be sent to the user informing the user of storage depletion in a message step 1504. The user is then asked if he/she desires additional space in an expand conditional step 1506. If no additional storage is requested, then control is transferred along a NO branch 1508 to a next command step 1510 where the message is canceled and the processor waits for the next command. If additional storage is requested, then control is transferred along a YES branch 1512 to a system request for user information in an request step 1514 where step determines the amount of additional storage needed 1516, verifies billing information 1518 and generates an authorization code 1520. All information is then forwarded to the server for verification and transaction processing in a server send step 1522. The information is tested at the server for validity in a validity test 1524. If the information is invalid, control is transferred along a NO branch 1526 to a error message step 1528 which forwarded back to the request step 1514. If the information is valid, control is transferred along a YES branch 1530 to a storage expansion routine 1532 which adds to the user's designated storage in open blocks 1534 via a storage expansion program 1536. After expansion, transaction data is sent to the billing system in a send billing system step 1538 and a confirmation is sent to the user in a confirmation step 1540.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

We claim:

1. An operating network implemented over a distributed computer network comprising:
remote DPUs including a kernel of the operating network and sufficient hardware resources to store the kernel and control extensions of desired applications and their associated routines and to interact with the kernel and to attach to a network
a server system including:
a supervisor server;
a support server;
an application software repository subsystem;
a user registration subsystem;
a user identification/verification subsystem;
a accounting/billing subsystem;
a subsystem adapted to support distributed computing and asset sharing among the servers and DPUs; and
a subsystem adapted to optimize server and DPU interaction and network performance;
where each supervisor server includes digital processing capabilities, memory, buses, peripherals, mass storage devices and communication devices and a supervisor server software package and each support server includes digital processing capabilities, memory, buses, peripherals, mass storage devices and communication devices and a support server software package; and
a network interconnecting the server system with the remote DPUs.

2. The operating network of claim 1, wherein the supervisor server software package and the support server software package includes the operating kernel and all other extensions to support full operating system capabilities.

3. The operating network of claim 1, wherein the supervisor server software package includes the operating kernel and all other extension to support full operating system capabilities and the support server software package includes sufficient software to execute executable agents received from supervisor servers or DPUs.

4. The operating network of claim 1, wherein the operating network adjusts its, OpNet, the size and needed components to a given DPU hardware

5. The operating network of claim 1, wherein the server system identifies and verifies each remote DPU at boot-up, downloads frequently used application software identified in a user profile associated with the DPU and icons or menus of application software in the repository subsystem for user selection and use.

6. The operating network of claim 1, wherein the operating network tracks application software usage and bills users on a use basis.

7. The operating network of claim 1, wherein the applications in the repository subsystem are automatically upgraded and optimized at upload to the receiving DPU.

8. The operating network of claim 1, wherein the DPUs further including resident software application environmentally tailored for the given DPU.

9. The operating network of claim 1, wherein the DPUs further include peripherals and other necessary hardware for full functionality.

10. An operating network comprising a kernel, an application software repository, a repository of dynamic routines needed by a given application for a given remote DPU to execute the application on the given remote DPU, communications software, a user information database, user registration, identification and verification routines, user accounting/billing routines, user application usage routines and dynamic response routines for automatically tuning the operating network, globally, locally or remotely.

11. The operating network of claim 10, wherein the remote DPU include routines for constructing agents to be forwarded to support servers that are only capable of executing such agents and time/date routines for monitoring application usage which is forwarded to the accounting/billing system.

12. A method for implementing an operating network comprising the steps of:
installing the kernel and communications hardware and software onto each DPU connected to the operating network,
installing the full operating network on a supervisor server of a server system of the operating network;
connecting the remote DPUs and the server system over a global information infrastructure or network;
interacting with the remote DPUs;
running user desired applications on the DPUs via the operating network where the executables reside on the operating network; and
tracking application usage by each remote DPU for accounting and billing purposes.

13. The method of claim 12, further comprising the step of:
billing each user of time usage of each application software used by the user over a given billing cycle.

14. An operating network comprising:
a server system including at least one supervisor server including a fully configured network operating system and application library, where the operating system includes a kernel and associated software for upgrading applications and dynamic routines in the library, user profiles for optimized DPU performance of remotely accessed application software, routines for adding application software to the library, accounting and billing routines, network optimization routines, networking upgrading routine, user identification, registration and verification routines and communication software;
remote DPUs including a kernel including routines on each remote DPU sufficient to support sending and receiving data and/or data streams for executing applications from each remote DPU without having the applications resident on each remote DPU and to support menus and menu selection; a graphics user interface for supporting user interaction through display devices and input devices; windowing software adapted to support and communications software; and
a global information infrastructure or network adapted to interconnect and allow two-way communication between the operating network's server system and the remote DPUs.

15. The network of claim 14, wherein the supervisor server software package includes the operating kernel and all other extensions to support full operating system capabilities.

16. The operating network of claim 14, wherein the supervisor server software package includes the operating kernel and all other extension to support full operating system capabilities and the support server software package includes sufficient software to execute executable agents received from supervisor servers or DPUs.

17. The operating network of claim 14, wherein the operating network adjusts its, OpNet, the size and needed components to a given DPU hardware

18. The operating network of claim 14, wherein the server system identifies and verifies each remote DPU at boot-up, downloads frequently used application software identified in a user profile associated with the DPU and icons or menus of application software in the repository subsystem for user selection and use.

19. The operating network of claim 14, wherein the operating network tracks application software usage and bills users on a use basis.

20. The operating network of claim 14, wherein the applications in the repository subsystem are automatically upgraded and optimized at upload to the receiving DPU.

21. The operating network of claim 14, wherein the DPUs further including resident software application environmentally tailored for the given DPU.

22. The operating network of claim 14, wherein the DPUs further include peripherals and other necessary hardware for full functionality.

23. A method for distributed and cost sharing use and support of application software and remote site hardware including interconnecting remote DPUs and a server with a global information infrastructure using an operating network of claim 14 and interacting with the network to gain access on a use based billing format to application software and hardware resources available on the operating network.
